(19) United States
(12) Patent Application Publication
(10) Pub. No.: US 2015/0055745 A1
(43) Pub. Date: Feb. 26, 2015

(54) Phase Contrast Imaging Using Patterned Illumination/Detector and Phase Mask

(71) Applicant: Carl Zeiss X-ray Microscopy, Inc., Pleasanton, CA (US)

(72) Inventors: Christian Holzner, Wettringen (DE); Michael Feser, Orinda, CA (US)

(21) Appl. No.: 14/464,954

(22) Filed: Aug. 21, 2014

Related U.S. Application Data
(60) Provisional application No. 61/869,187, filed on Aug. 23, 2013.

(51) Int. Cl. G01N 23/20; G21K 7/00; G01N 23/04

(52) U.S. Cl. CPC G01N 23/20075; G01N 23/04; G21K 7/00
USPC 378/36

(57) ABSTRACT

A modified phase shifting mask is used to improve performance over traditional Zernike phase contrast imaging. The configurations can lead to an improved imaging methodology potentially with reduced artifacts and more than one order of magnitude gain in photon efficiency, in some examples. Moreover, it can be used to yield a direct representation of the sample's phase contrast information without the need for additional specialized post-acquisition image analysis. The approach can be applied to both wide-field and scanning configurations by using a phase mask including a pattern of phase elements and an illumination mask, having a pattern of holes, for example, that corresponds to a pattern of the phase mask.

### RELATED APPLICATIONS

This application claims the benefit under 35 USC 119(e) of U.S. Provisional Application No. 61/869,187, filed on Aug. 23, 2013, which is incorporated herein by reference in its entirety.

### BACKGROUND OF THE INVENTION

X-rays, due to their high penetration power and possibility of an extended depth-of-field due to their short wavelength, are ideally suited for imaging thick and embedded soft and biological materials. In some energy ranges and/or samples including low-Z elements, phase contrast (PC) significantly dominates over absorption in transmission imaging. Thus, features that are difficult or impossible to observe in absorption contrast can be effectively studied in phase contrast mode.

Various methods of phase contrast imaging exist. Zernike PC was developed by Frits Zernike (see F. Zernike, “Das Phasenkontrastverfahren bei der mikroskopischen Beobachtung.” Z. Techn. Physik. 16, 454-457 (1935)) for wide-field optical microscopy using a phase shifting annular mask in the back focal plane of the objective lens of a wide-field microscope in combination with an annular condenser illumination. This method directly reveals the phase shift introduced by the object. Schmahl et al. have used this method for wide-field x-ray microscopy (U.S. Pat. No. 5,550,887). The technique is well established in many wide-field x-ray, electron and optical microscopes. According to the principle of reciprocity in optics, this method can also be implemented on scanning microscopes. Siegel et al. describe this in U.S. Pat No. 4,953,188.

Zernike phase contrast imaging is similar to absorption contrast imaging and can be achieved by modifying a microscope, which was set up for absorption contrast, by adding additional optical elements. For traditional wide-field microscopes, Zernike phase contrast is implemented by using an annular aperture in or near the plane of the condenser lens in combination with an annular phase shifting ring in or near the back focal plane of the microscope objective. The phase plate is chosen to be transparent or semi-transparent with a thickness to phase shift the radiation of +/−π/2,+/−3π/2, or generally (2n+1) π/2 where n=0,+/−1,+/−2, etc. The choice and sign of n selects either positive or negative phase contrast imaging modes. When ray tracing the path of the light in the Zernike PC microscope, the annular illumination light from the condenser is chosen to match with the phase plate in the back focal plane. According to Abbe's theory of image formation, the presence of the sample produces a scattered light field that will not pass through the phase plate in the back focal plane of the objective lens. This scattered light contains the structure information of the sample. The interference of this scattered light field with the unscattered light going through the phase ring produces on the detector the desired Zernike phase contrast image. This method has been widely used in light microscopy, electron microscopy and x-ray microscopy with great success.

Scanning PC microscope systems have also been developed. Examples include differential PC using a segmented detector (see B. Hornberger et al., “Differential phase contrast with a segmented detector in a scanning x-ray microprobe,” J. Synchrotron Rad. 15, 355-362 (2008)) or more advanced schemes such as ptychography (see P. Thibault et al., “High-Resolution Scanning X-ray Diffraction Microscopy,” Science. 321, 379-382 (2008)). These methods, however, require specialized and post-acquisition image analysis in order to yield a proper sample representation and do not deliver a direct phase contrast image that can easily be interpreted.

More recently, by employing methods from wide-field microscopy and the basic imaging principle of reciprocity, scanning-type Zernike PC using x-rays has been demonstrated for the first time as a new and alternative method, which directly visualizes the sample's phase contrast information with no need for image processing. See C. Holzner, M. Feser, S. Vogt, B. Hornberger, S. B. Baines and C. Jacobsen, “Zernike phase contrast scanning microscopy with X-rays,” Nat. Phys. 6, 883-887 (Nov. 2010).

The major limitation of Zernike PC imaging is that its image contrast significantly decreases with increased sample feature size. Further, halo artifacts at feature edges and boundaries are inherent in Zernike PC images. The underlying cause for this is the spatial frequency dependent contrast transfer of the Zernike PC method. In particular, at low spatial frequencies (large features) the contrast transfer is very low. The artifacts can make image interpretation, and specifically quantitative analysis, difficult or even impossible. Thus, generally, Zernike phase contrast imaging is usually acceptable for observing the features' morphology qualitatively, both in two (2D) and three (3D) dimensions. For quantitative and computer based image processing, these artifacts become more problematic and a solution to the non-quantitative nature of the images is desired.

Moreover, with three dimensional (3D) imaging, e.g. computed tomography (CT) techniques, these artifacts lead to severe distortions and amplified artifact structures in the 3D data. This is because the CT reconstruction algorithm requires each 2D projection image to consist of the linear sum of some characteristic through the sample, e.g. the attenuation coefficient in the case of absorption contrast images. In order to effectively combine the phase-contrast imaging technique with 3D CT imaging, one must derive the linear phase shift through the sample from images that have both absorption and phase contrast signals. Another challenge is the automated separation of specimen constituents by segmentation after the tomographic reconstruction of a tilt series when these artifacts are present.

More recently, M. Stampanoni described a wide-field PC system that utilizes a beam shaping condenser and a dot array as phase shifting mask, which noticeably reduces the typical Zernike artifacts and increases the photon efficiency. See M. Stampanoni et al., “Phase-contrast tomography at the nanoscale using hard x rays,” Phys. Rev. B81, 140105(R) (2010). This implementation, however, relies on the high degree of coherence (laser-like property) of the synchrotron source employed in this demonstration and could not be implemented using large spot laboratory sources.

### SUMMARY OF THE INVENTION

Scanning Zernike PC suffers from similar imaging artifacts as in the wide-field case. These artifacts are mainly due to the ring-shaped phase shifting mask, leading to the loss of low spatial frequencies in the imaging process and a subsequent haloing around sample feature edges. In the scanning-type case the phase ring represents a second disadvantage, as it is only the intensity in the phase ring's far-field projection that is meaningful to the image formation. However, this signal represents only approximately 2% of the incident probing intensity, making inefficient use of photons.

The invention uses a modified phase shifting mask with increased efficiency. Using this configuration, the disadvantages of Zernike PC can be minimized and the configuration can lead to an improved imaging methodology potentially with drastically reduced artifacts and more than one order of magnitude gain in photon efficiency, in some examples. Moreover, it can be used to yield a direct representation of the sample's phase contrast information without the need for additional post-acquisition image filtering and/or analysis. The increase in photon efficiency achieved through the usage of the phase shifting mask in conjunction with the illumination mask correspondingly increases imaging throughput as compared to current systems and methods. The approach can be applied to both wide-field and scanning configurations. It also can be implemented using laboratory x-ray sources.

In general, according to one aspect, the invention, which is applicable to both scanning and wide-field configurations, features a phase contrast imaging system comprising a radiation source for generating radiation, a detector for detecting the radiation after transmission through a sample, a patterned phase mask for phase shifting a portion of the radiation detected by the detector, and an illumination mask, having a pattern that corresponds to a pattern of the phase mask.

In a first embodiment, the imaging system is a scanning x-ray microscope in which the illumination mask is located between the sample and the detector or implemented in the operation of the detector. The system includes an objective lens that focuses the radiation after transmission through the phase mask onto the sample.

The first embodiment additionally has a number of characteristics. In one example, the detector is a spatially resolved pixelated detector and the illumination mask is implemented by summing responses of pixels to form the pattern of the illumination mask. In another example, the detector is a single element detector and the illumination mask is an opaque detector mask over the single element detector.

In another characteristic, the phase mask is located between the sample and the radiation source.

In a second embodiment, the imaging system is a wide-field x-ray microscope in which the illumination mask is located prior to the sample. The illumination mask comprises a membrane including transparent regions and opaque regions to form the illumination mask. The transparent regions are preferably radiation-transmitting holes.

In other characteristics of the second embodiment, the phase mask is located between the sample and the detector. In addition, the system includes an objective lens that images the radiation after transmission through the sample onto the detector.

The second embodiment also includes a condenser optic that illuminates the sample with the radiation from the radiation source in some examples.

Additionally, the imaging system has a number of characteristics that are common to both embodiments. A laboratory x-ray source can be used to generate the radiation. In examples, the phase mask matches the pattern of the illumination mask. Alternatively, the pattern of the phase mask matches a conjugate of the pattern of the illumination mask. Preferably, the phase mask comprises phase elements distributed in the pattern that phase shift radiation of some of the radiation generated by the radiation source. The phase elements phase shift radiation scattered by the sample with respect to radiation that is not scattered by the sample. Preferably, a fill factor of the phase elements is less than 50%.

Additionally, the phase elements can be spatially distributed over the phase mask in a regular array fashion for forming the pattern of the phase mask. Alternatively, the pattern is a non-regular array of the phase elements.

In embodiments, the imaging system includes an image processor that creates tomographic reconstructions of the sample in response to the radiation detected by the detector.

In general, according to another aspect, the invention features a phase contrast imaging method comprising generating radiation, detecting the radiation after transmission through a sample, phase shifting a portion of the radiation detected, and masking radiation from detection with a pattern that corresponds to a pattern of the phase shifting mask.

The above and other features of the invention including various novel details of construction and combinations of parts, and other advantages, will now be more particularly described with reference to the accompanying drawings and pointed out in any claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic view of a scanning imaging microscope according to an embodiment of the present invention;

FIG. 2 is a schematic view of a wide-field imaging microscope according to another embodiment of the present invention;

FIG. 3A is a front plan view of an illumination mask for the wide-field imaging microscope;

FIG. 3B is a front plan view of a phase shifting mask for the wide-field imaging microscope that is matched to the illumination mask of FIG. 3A; and

FIG. 4A is an image of a test structure generated using a conventional Zernike PC phase ring, FIG. 4B is an image of the test structure generated using a PC phase ring/illumination mask according to the present invention with periodic opaque elements in the illumination mask, FIG. 4C is an image of the test structure generated using a PC phase ring/illumination mask according to the present invention with randomly distributed opaque elements in the illumination mask with unit cell constraints, and FIG. 4D is an image of the test structure generated using a PC phase ring/illumination mask according to the present invention with randomly distributed opaque elements in the illumination mask.

### DETAILED DESCRIPTION OF THE PREFERRED EMBODIMENTS

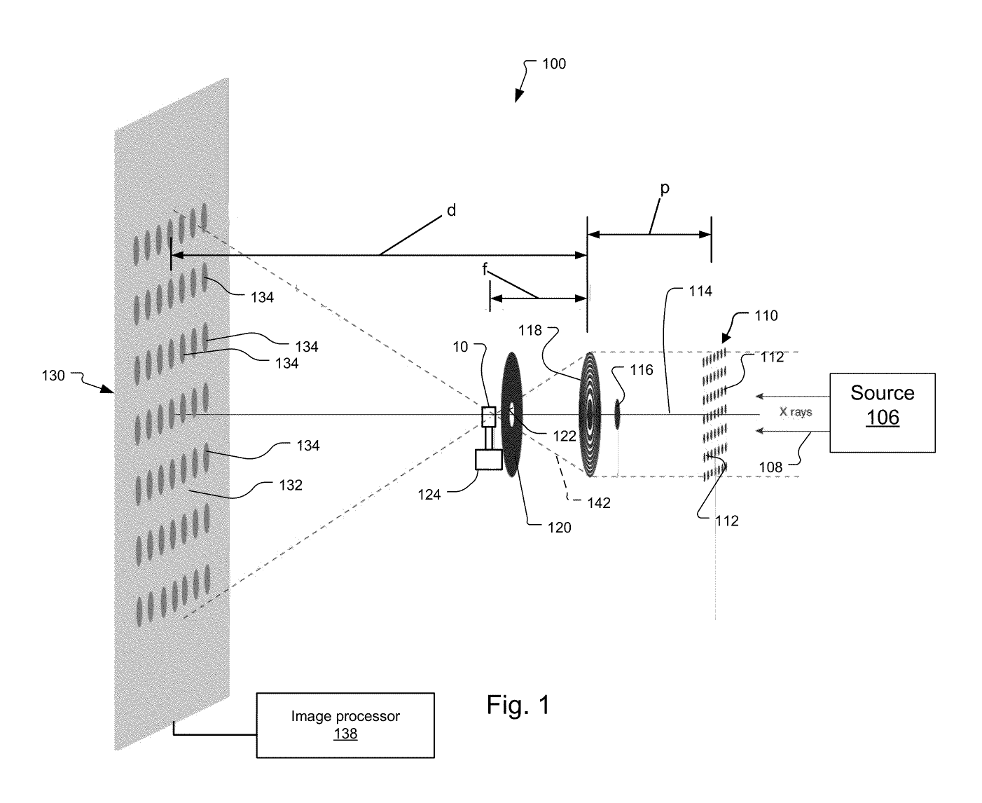

FIG. 1 shows a scanning imaging microscope 100 constructed according to a first embodiment of the present invention.

Radiation 108 is generated by a radiation source 106. Typically, this radiation is intrinsically narrowband radiation or broadband radiation that is filtered by a bandpass filter to be narrowband. In the illustrated example, the radiation is generally collimated.

In the preferred embodiment, the radiation 108 is x-ray radiation having an energy between 0.2 keV and 100 keV. Some specific examples of the source 106 include a sealed tube x-ray source, a rotating anode x-ray source, a micro-focus x-ray source, metal jet micro-focus x-ray source, or a synchrotron radiation source. Some of these sources include an integrated or separate collimator.

In the example of an electron microscope, the source 106 generates radiation that is an electron beam, having an energy between 10 keV and 1 MeV.

A phase plate or mask 110 phase shifts a portion of the radiation so that the radiation that is scattered by the sample 10 interferes with unscattered radiation to form the projection image.

In the illustrated embodiment, the phase mask 110 comprises an array of dots or phase elements 112. In the specific illustrated implementation, the array is a regular array. The material of the phase plate 110 and its thickness relative to the wavelength of the source radiation 108 has the effect of shifting the phase of the radiation 108 transmitted through the dots or phase elements 112 by typically π/2 or 3π/2 relative to the radiation that passes through the plane of the phase plate 110 but does not encounter a dot 112. More generally, the phase shift needs to be:

phase shift=((2*n+1)/2)*π+/−π/4,

where n can be any whole positive or negative number including zero. The +/- π/4 is a very conservative tolerance and if the phase shift is not exactly equal to ((2*n+1)/2)*π, some mixing of phase and absorption contrast imaging will occur.

In the illustrated embodiment, the phase elements 112 are cylindrical (circle extrusions) having an axis that is parallel to the optical axis 114 of the system. In other embodiments, square phase elements 112 or other shaped extrusions are used. Alternatively, the phase shifting elements 112 can be fabricated by removing material from the substrate of the phase plate 110 to produce the relative phase shift.

In the illustrated embodiment, the phase elements 112 form a regular array. Examples include arranging the phase elements in a grid or periodic fashion. In other embodiments, however, the phase elements form a non-regular array, such as when the phase elements 112 are randomly or pseudo-randomly distributed over the extent of the phase plate 110. This is the preferred embodiment to obtain even spatial frequency contrast transfer in the scanning imaging system 100, which correspondingly minimizes the creation of artifacts in the projection images generated by the system.

Also, in the illustrated embodiment, the fill factor of the phase elements 112 compared to the portions of the phase plate 110 that include no phase elements is approximately 20%. Generally, the fill factor, or the percentage of the phase plate 110 that is covered with phase elements 112, should be between a few percent and 50 percent.

In terms of size, generally the smaller the size of the phase elements 112, the better for reduction of artifacts in the imaging process due to uneven spatial frequency contrast transfer. Ideally the size of the phase elements 112 would be the same as or smaller than the system resolution as determined by the numerical aperture of the lens. In this ideal imaging system, no artifacts would exist and the images would be ideal phase contrast images. In practical systems, this is very difficult to achieve due to manufacturing constraints of the phase mask 110 and the requirement to keep the phase mask position stable to a small fraction of its size relative to the other optical elements. In a typical embodiment, the size of the phase elements 112 would be chosen to be in the range of 5-100 times the system resolution.

In some examples, the phase elements are all approximately the same size with respect to each other. In other examples, the sizes of the phase elements 112 vary across the phase mask 110 such that some of the phase elements are two or more times larger in terms of area than other phase elements.

Along the optical axis 114 is a cylindrical central stop 116. This central stop 116 absorbs or blocks radiation along the optical axis 114. Preferably, the area of the central stop 116 is 50 percent or less compared with the area of the objective lens 118.

A focusing objective element 118, located at a distance p from the phase mask 110, focuses the radiation 108 onto the sample 10. In the illustrated embodiment, a zone plate objective 118 is used, which is a distance f from the sample 10. In other embodiments, reflective optics such as a capillary or Wolter reflective condenser is used. In still other embodiments, focusing elements such as compound refractive lenses or KB-mirrors are used.

An order-sorting aperture 120 is then provided. It has a central aperture 122 that is sized to the central stop 116. It is chosen to be slightly smaller than the central stop 116. This order sorting aperture 120 blocks radiation 108 that is not focused by the focusing element 118.

The sample 10 is located at the focal plane of the focusing element 118. The sample 10 is held by a sample holder 124.

The radiation transmitted through the sample 10 is then detected by a detector 130 that is located a distance d from the zone plate objective 118.

The detector 130 includes active photosensitive regions 134 and inactive regions 132 to thereby form an illumination mask.

According to the invention, in one example, the pattern of the detector's illumination mask, and specifically the active regions 134 on the detector 130, matches the pattern of the phase elements 112 of the phase plate 110. The size and position of the pattern of the active regions 134 are adjusted for the magnification of the system, however. Further, the pattern of the illumination mask is point mirrored (inverted) with respect to the pattern of the phase elements 112 due to the lens 118.

It should be noted that the pattern of the detector's illumination mask can match the pattern of the phase elements 112 of the phase plate 110 in terms of being its conjugate as well.

In one embodiment, the detector 130 is simply a large area, single element detector. In this case, the active regions 134 correspond to radiation-transmitting hole structures of an opaque physical detector mask that is placed over a photosensitive region of the detector 130.

In another embodiment, the detector 130 is a spatially resolved, pixelated detector. In this example, summing the responses of only the pixels that fall within the active regions 134 are used in the formation of the image to thereby functionally provide or form the pattern of the illumination mask. Preferably, the spatially resolved detector 130 has a high resolution having greater than 1024×1024 pixels. Alternatively, one can use a long distance between the detector 130 and the sample 10 to further magnify the dots 112 of the phase plate 110 on the detector 130 and thus use a very coarse detector 130 with larger pixels.

In some cases, a direct detection scheme is used in which a CCD or CMOS detector or other electronic detector 130 is used to detect the radiation 108, when lower energy radiation such as soft x-rays are used, for example. However, with higher energies, intervening scintillators are employed to enable detection of the radiation 108 by conversion into the optical frequencies. In such cases, intervening fold mirrors can be added so that the electronic detector 130 is not irradiated by x-rays.

In the illustrated example of a scanning system, the focal spot is scanned over the area of interest of the sample 10. This is achieved by creating relative movement between the focal spot and the sample 10. In one example, the focal spot is raster scanned over the sample 10. In another example, the sample holder 124 moves the sample 10 in the radiation 108. That is, the instrument is stationary and the sample 10 is raster scanned through the focal spot, as is most commonly the case for x-ray imaging.

Preferably, the sample holder 124 further rotates the sample 10 in the radiation 108 to enable the generation of different projections through the sample, enabling tomographic reconstruction of the sample 10.

The detector 130 generates an image representation of the radiation that is scattered by the sample 10 in conjunction with radiation unscattered by the sample to form the projection image.

The imaging system 100 also includes an image processor 138 that accepts the image projections from the detector 130 and creates a tomographically reconstructed volume of the sample 10 from the projection images, in one mode of operation, from the separate projection images.

Operators of the imaging system 100 can choose different variations of the phase mask 110 for each scan run to induce different phase shifts for the radiation scattered by the sample 10. Selection of positive values of n for the phase shift creates positive phase-shifted projection images of the sample 10. Within the images, the phase-shifted light due to scattering of the radiation 108 by features of the sample 10 appears as foreground or bright spots compared to darker background features associated with unscattered light. Conversely, selection of a phase mask using negative values of n for the phase plate 110 creates negative phase-shifted projection images of the sample 10.

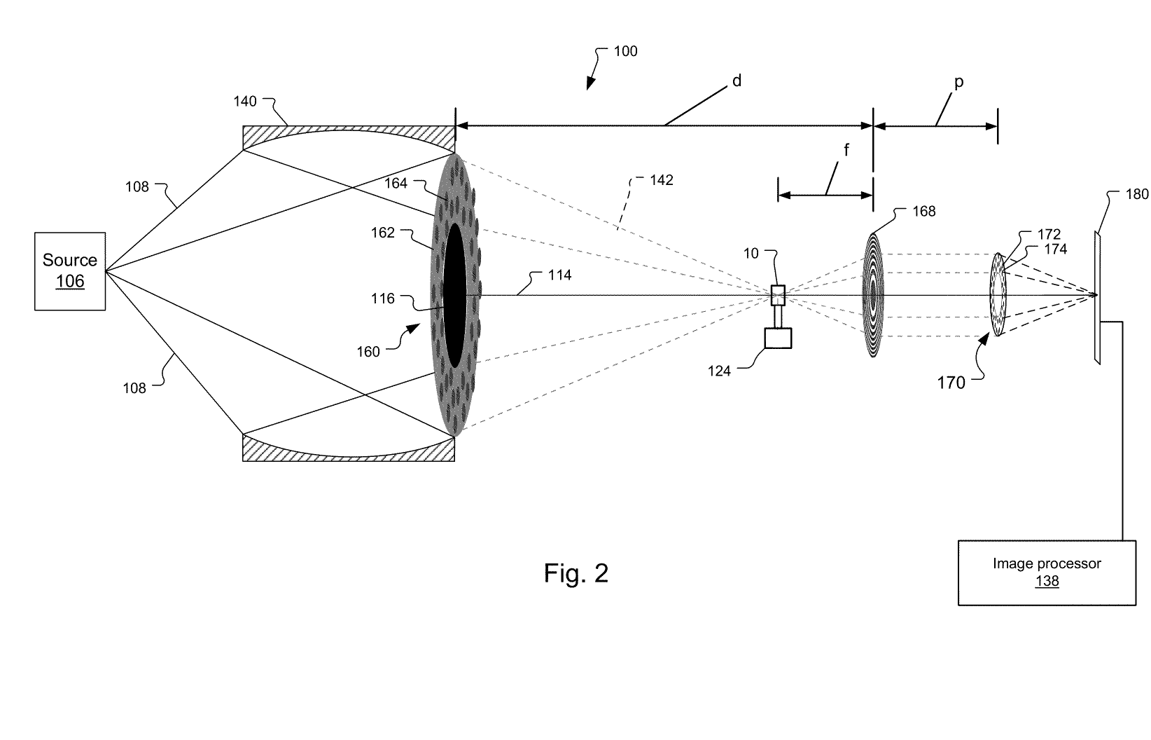

FIG. 2 shows a wide-field imaging microscope 100 constructed according to a second embodiment of the present invention.

Radiation 108 is similarly generated by a radiation source 106. The figure shows radiation 108 radiating out as from a point source, which is consistent with radiation generated from a laboratory source such as a sealed tube source, a rotating anode x-ray source, metal jet micro-focus source, or a micro-focus x-ray source, in examples.

But here also, in other examples, the radiation 108 is generated by a synchrotron or other x-ray radiation source. In this case, a more collimated beam would be provided.

In other embodiments, the radiation 108 is an electron beam.

If a laboratory x-ray source is used, then typically a reflective condensing element is often preferred. In the illustrated example, a cylindrical capillary condenser 140 collects the radiation radiating from the source 106 and focuses the radiation.

A converging cone of radiation 142 directed toward the sample 10 is created by including a central stop 116 aligned along the optical axis 114 and preferably centered in the exit aperture of the condenser 140.

An illumination mask 160 is located in the beam of radiation 108 preferably between the condenser 140 and the sample 10.

In the current embodiment, the illumination mask 160 has an array of transparent circular regions 164 that transmit radiation. The regions 164 are included within an opaque membrane 162. A material of the opaque membrane 162 is selected to prevent the transmission of the radiation 108 through the membrane 162. In one example, the membrane is metal, such as gold, and the regions 164 are holes in that gold membrane 162. The holes enable transmission of the radiation 108 through the otherwise opaque membrane 162.

Alternatively, one can use the opposite pattern for the illumination mask 160 with opaque regions 164, and a transparent membrane 162. Here, the transparent membrane 162 provides mechanical support for the opaque, e.g., gold, regions 164.

The converging cone of radiation 142 passing through the sample 10 is imaged onto a spatially resolved detector 180 by an objective lens 168, which is typically a Fresnel zone plate lens, when the radiation is x-ray radiation. In other examples, a compound refractive lens (CRL) or other image forming x-ray optic can be utilized as the objective lens 168. The transmitted radiation includes radiation that was unscattered by the sample 10 and radiation/light that was scattered by the sample 10. The objective lens 168 is a distance d from the condenser 140, and the objective lens 168 is a distance f from the sample 10.

Typically, the spatially resolved detector 180 has a high resolution having greater than 1024×1024 pixels. In some cases, a direct detection scheme is used in which a CCD detector or other electronic detector is used to detect the radiation, when optical frequencies or soft x-rays are used. However, with higher energies an intervening scintillator, and possibly a fold mirror, is typically employed to enable detection of the radiation by first converting it into the optical frequencies.

A phase mask 170 is a distance p from the objective lens 168 and is located between the objective lens 168 and the detector 180. The phase mask 170 induces a phase shift between the light that is not scattered by the sample relative to the light that is scattered by the sample 10 so that they interfere with each other at the detector 180.

The phase mask or plate 170 is placed in the back focal plane of the objective lens 168. The placement is such that the distances fulfill the lens equation 1/f=1/d+1/p. The material of the phase plate and its thickness relative to the wavelength of the source radiation 108 has the effect of shifting the phase of the radiation transmitted through the phase plate 170 by typically π/2 or 3π/2. As discussed previously, more generally, the phase shift needs to be:

phase shift=((2*n+1)/2)*π+/−π/4,

where n can be any whole positive or negative number including zero.

The phase mask or plate 170 comprises an array of dots or phase elements 172. The material of the phase plate 170 and its thickness relative to the wavelength of the source radiation 108 has the effect of shifting the phase of the radiation 108 transmitted through the dots or phase elements 172 by typically π/2 or 3π/2 relative to the radiation that is passes through the plane of the phase plate 170 but does not encounter a dot or phase element 172.

In the illustrated embodiment, the phase elements 172 are cylindrical dots. In other embodiments, square phase elements 172 or other shapes are used.

Also, in the illustrated embodiment, the phase elements 172 form an irregular array. In other embodiments, however, the phase elements 172 are arranged in a regular array. Preferably, the phase elements 172 are randomly distributed or pseudo-randomly distributed over the extent of the phase plate 170.

Also, in the illustrated embodiment, the fill factor of the phase elements 172 compared to the portions 174 of the phase plate 170 that have no phase elements 172 is approximately 20%. Generally, the fill factor should be between a few percent and 50 percent.

According to the invention, the pattern of the phase elements 172 of the phase plate 170 matches the pattern of the transparent hole elements 164 in the opaque membrane 162 of the illumination mask 160 in terms of being the same or its conjugate. The size and position of the pattern of the phase elements 172 are adjusted, however, for the magnification of the system. In addition, the representation of the phase plate pattern is point-mirrored with respect to the optical axis 114; i.e. imaging through the objective lens turns the picture up-side down. As a result, the radiation 108 that is phase shifted by the phase elements 172 is only the radiation that is unscattered by features or structures within the sample 10 and thus contributes to the formation of the projection image on the image plane of the detector 180 by interference with the scattered radiation.

The wide-field imaging microscope 100 similarly includes an image processor 138 for creating tomographically reconstructed volumes of the sample 10 from the projections images.

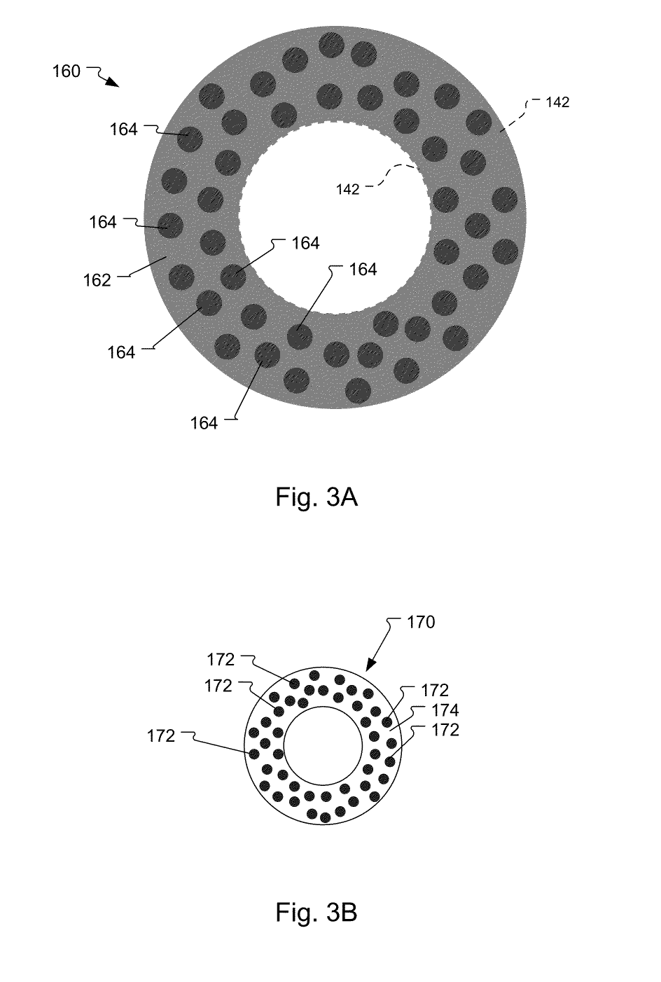

FIG. 3A and 3B illustrate the relationship between the illumination mask 160 and the phase mask 170 for the wide-field embodiment of the imaging system 100 in FIG. 2. Specifically, the pattern of the transparent elements 164 matches (point-mirrored) the pattern of the phase elements 172 of the phase mask 170.

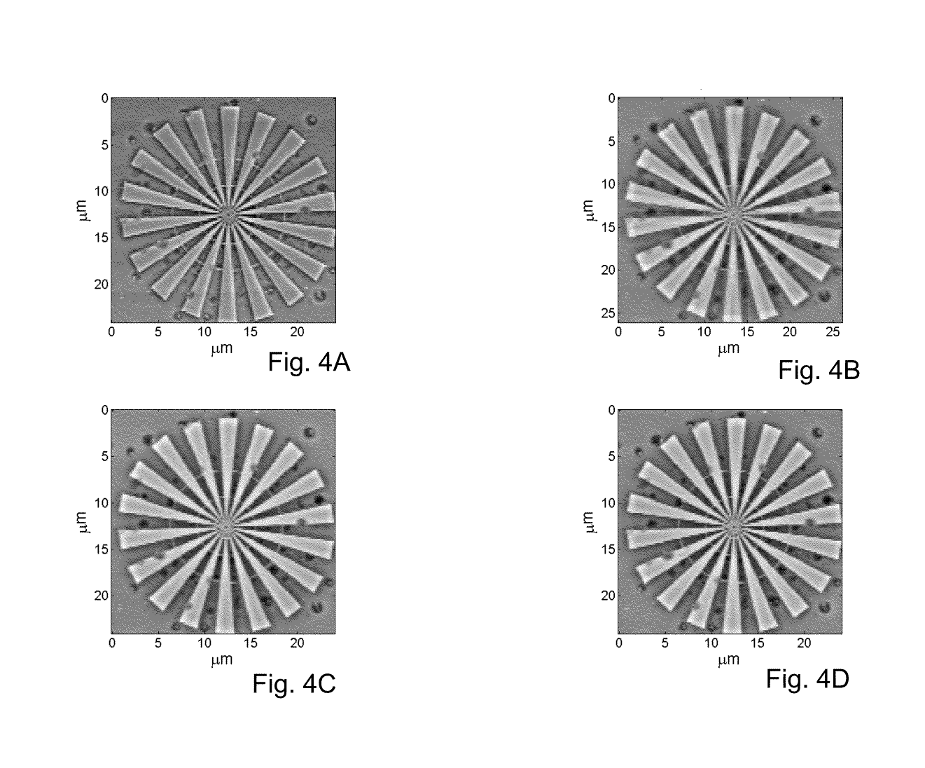

FIG. 4A though 4D show generated PC images of a common test pattern sample.

FIG. 4A shows an image generated using a conventional Zernike PC phase ring. FIG. 4B through FIG. 4D show patterns generated using different configurations of the inventive combination phase mask/illumination mask. Because the images of FIG. 4B-4D were generated using a scanning configuration, the reference numbers refer to elements of the scanning configuration of FIG. 1. However, the images could also have been generated using the wide field configuration of FIG. 2 with substantially similar results.

FIG. 4B shows an image generated using a periodic (regular array) arrangement of regions 134 of the illumination mask/phase elements 112 of the phase mask 112. FIG. 4C shows an image generated when the regions 134/phase elements 112 are spatially distributed in a random fashion with an additional unit cell constraint. Finally, FIG. 4D shows an image generated when the regions 134/phase elements 112 are spatially distributed in a random fashion.

While this invention has been particularly shown and described with references to preferred embodiments thereof, it will be understood by those skilled in the art that various changes in form and details may be made therein without departing from the scope of the invention encompassed by the appended claims.

What is claimed is:

1. A phase contrast imaging system, comprising:
a radiation source for generating radiation;
a detector for detecting the radiation after transmission through a sample;
a patterned phase mask for phase shifting a portion of the radiation detected by the detector; and
an illumination mask having a pattern that corresponds to a pattern of the phase mask.

2. The imaging system as claimed in claim 1, wherein the imaging system is a scanning x-ray microscope in which the illumination mask is located between the sample and the detector or implemented in an operation of the detector.

3. The imaging system as claimed in claim 2, further comprising an objective lens that focuses the radiation after transmission through the phase mask onto the sample.

4. The imaging system as claimed in claim 2, wherein the detector is a spatially resolved pixelated detector and the illumination mask is implemented by summing responses of pixels to form the pattern of the illumination mask.

5. The imaging system as claimed in claim 2, wherein the detector comprises a single element detector and the illumination mask is an opaque detector mask over the single element detector.

6. An imaging system as claimed in claim 2, wherein the phase mask is located between the sample and the radiation source.

7. An imaging system as claimed in claim 1, wherein the imaging system is a wide-field x-ray microscope in which the illumination mask is located prior to the sample.

8. The imaging system as claimed in claim 7, wherein the illumination mask comprises a membrane including transparent regions and opaque regions to form the illumination mask.

9. The imaging system as claimed in claim 8, wherein the transparent regions are radiation-transmitting holes.

10. The imaging system as claimed in claim 7, wherein the phase mask is located between the sample and the detector.

11. The imaging system as claimed in claim 7, further comprising an objective lens that images the radiation after transmission through the sample onto the detector.

12. The imaging system as claimed in claim 7, further comprising a condenser optic that directs the radiation from the radiation source onto the sample.

13. An imaging system as claimed in claim 1, wherein the radiation source is a laboratory x-ray source for generating the radiation.

14. The imaging system as claimed in claim 1, wherein the pattern of the phase mask matches the pattern of the illumination mask.

15. The imaging system as claimed in claim 1, wherein the pattern of the phase mask matches a conjugate of the pattern of the illumination mask.

16. The imaging system as claimed in claim 1, wherein the phase mask comprises phase elements distributed in the pattern that phase shift radiation of some of the radiation generated by the radiation source.

17. The imaging system as claimed in claim 16, wherein a fill factor of the phase elements is less than 50%.

18. The imaging system as claimed in claim 16, wherein the pattern is a regular array of the phase elements.

19. The imaging system as claimed in claim 16, wherein the pattern is a non-regular array of the phase elements.

20. The imaging system as claimed in claim 1, further comprising an image processor that creates tomographic reconstructions of the sample in response to the radiation detected by the detector.

21. A phase contrast imaging method, comprising:
generating radiation;
detecting the radiation after transmission through a sample;
phase shifting a portion of the radiation to be detected; and
masking radiation from detection with a pattern that corresponds to a pattern of the phase shifting.

22. The method as claimed in claim 21, further comprising performing the masking of the radiation prior to detecting the radiation or implementing the masking of the radiation in an operation of a detector.

23. The method as claimed in claim 21, further comprising performing the phase shifting of the radiation prior to the radiation propagating through the sample.

24. The method as claimed in claim 21, further comprising masking of the radiation prior to the radiation propagating through the sample.

25. The method as claimed in claim 21, further comprising utilizing an illumination mask including transparent regions and opaque regions for masking the radiation from detection.

26. The method as claimed in claim 25, wherein the transparent regions are radiation-transmitting holes for providing the pattern of the masking.

27. The method as claimed in claim 21, further comprising performing the phase shifting after the radiation is transmitted through the sample.

28. The method as claimed in claim 21, further comprising imaging the radiation onto the detector after transmission through the sample.

29. The method as claimed in claim 21, further comprising condensing and directing the radiation onto the sample prior to masking the radiation.

30. The method as claimed in claim 21, further comprising generating the radiation with a laboratory x-ray source.

31. The method as claimed in claim 21, further comprising matching the pattern of the phase shifting to the pattern of the radiation masking.

32. The method as claimed in claim 21, further comprising matching the pattern of the phase shifting to a conjugate of the pattern of the radiation masking.
